(19) United States
(12) Patent Application Publication
(10) Pub. No.: US 2017/0061372 A1
(43) Pub. Date: Mar. 2, 2017

(54) VERIFICATION AND PAYMENT FOR PACKAGE DELIVERY

(71) Applicant: CA, INC., New York, NY (US)

(72) Inventor: Gaurav AGARWAL, Bangalore (IN)

(73) Assignee: CA, INC., New York, NY (US)

(21) Appl. No.: 14/840,620

(22) Filed: Aug. 31, 2015

(51) Int. Cl. G06Q 10/08; G06Q 20/42; G06K 19/06; G06Q 20/36; G06Q 20/38; G06Q 20/40; G06Q 20/20

(52) U.S. Cl. CPC G06Q 10/0835; G06Q 20/401; G06Q 20/42; G06Q 20/208; G06Q 20/3674; G06Q 20/3829; G06K 19/06037; G06Q 2220/00

(57) ABSTRACT

A method of verifying a package delivery includes electronically reading a package shipment code on a package delivered to an address, transmitting the package shipment code to a transaction server, receiving a confirmation message including a transaction amount from the transaction server, displaying the confirmation message to a user, receiving a payment authorization from the user in response to the confirmation message, and sending payment information to a payment processing server in response to receiving the payment authorization from the user.

### FIELD

The inventive concepts described herein relate to software applications for mobile computing devices. In particular, the inventive concepts relate to computer systems and software applications and related methods that enable secure delivery of packages, verification of package delivery and/or payment for package delivery.

### BACKGROUND

COD refers to a process in which payment for delivered goods is made at the time of delivery, rather than in advance. The term COD originally applied only to payment by cash (hence, “COD” stood for “cash on delivery”). However, as other forms of payment, such as payment by checks, credit cards, debit cards, and the like, have become more common, the word “cash” has largely been replaced with the word “collect.” Thus, the term COD can refer to “cash on delivery” or “collect on delivery.”

Although COD was pioneered before the development of the Internet and online retail, COD remains popular in some countries, particularly for purchases from internet-based retailers, because it can benefit both the vendor and the purchaser. Many small businesses prefer cash payments over credit card payments to avoid having to pay a transaction fee to a card issuer. Moreover, some purchasers may prefer to use COD for purchases from online vendors, since the purchaser may not want to provide credit card information to the retailer, and/or they may want to ensure that the package has been successfully delivered before issuing payment for the delivery.

### SUMMARY

A method of verifying a package delivery includes electronically reading a package shipment code on a package delivered to an address, transmitting the package shipment code to a transaction server, receiving a confirmation message from the transaction server, the confirmation message including a transaction amount, displaying the confirmation message to a user, receiving a payment authorization from the user in response to the confirmation message, and sending payment information to a payment processing server in response to receiving the payment authorization from the user.

The method may further include receiving a payment token. Sending the payment information to the transaction server may include sending the payment token to the transaction server

Reading the package shipment code on the package may include scanning a visible symbol printed on the package.

The visible symbol may include a bar code and/or a QR code.

Reading the package shipment code may further include reading package information about the package from the visible symbol.

The method may further include transmitting the package information to the transaction server along with the package shipment code.

The package information may include a shipping address, and the method may further include transmitting the package information including the shipping address to the transaction server along with the package shipment code.

The method may further include receiving a payment confirmation from the payment processing server.

The method may further include generating a cryptogram that includes an encoded payment key in response to receiving the payment authorization, wherein the payment information includes the cryptogram.

A method of verifying a package delivery includes electronically reading a package shipment code on a package delivered to an address, transmitting the package shipment code to a transaction server, receiving a confirmation message from the transaction server, the confirmation message including a transaction amount, displaying the confirmation message to a user, receiving a payment authorization from the user in response to the confirmation message,

transmitting a payment verification to the transaction server in response to the payment authorization, and receiving a payment confirmation from the transaction server in response to the payment verification.

A method of verifying a package delivery includes receiving shipment information from a vendor, the shipment information describing a shipment of a package to a recipient and including a first package shipment code, receiving a second package shipment code from a mobile computing device associated with the recipient, comparing the first package shipment code and the second package shipment code, and if the first and second package shipment codes match, sending a payment authorization to the mobile computing device authorizing the recipient to accept the package and pay for delivery of the package.

The method may further include receiving payment information from the mobile computing device, and forwarding the payment information to a payment processor that processes payments on behalf of the vendor.

The payment information may include a cryptogram including payment card information.

The payment information may include electronic payment account credentials.

The method may further include receiving a payment verification from the payment processor, the payment verification verifying that the payment information was successfully processed, and transmitting the payment verification to the mobile computing device.

The shipment information may identify a courier server operated by a courier service that delivers the package to the recipient, and the method may further include transmitting a message to the courier server authorizing the courier service to release the package to the recipient.

The method may further include receiving payment information from the mobile computing device, and forwarding the payment information to a vendor server operated by the vendor.

The payment authorization may include a payment amount.

The method may further include sending a message to the vendor requesting the shipping information after receiving the second shipment code from the mobile computing device.

The shipping information may include a decryption key, and the method may further include decrypting the first package shipping code using the decryption key.

Other methods, computer program products, and/or electronic devices according to embodiments of the present disclosure will be or become apparent to one with skill in the art upon review of the following drawings and detailed description. It is intended that all such methods, computer program products, and/or electronic devices be included within this description, be within the scope of the present inventive subject matter, and be protected by the accompanying claims. Moreover, it is intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram illustrating various elements of a system for secure package delivery according to some embodiments.

FIG. 2 is a block diagram illustrating a transaction server according to some embodiments.

FIG. 3 is a block diagram illustrating a mobile computing device according to some embodiments.

FIGS. 4 and 5 are flow diagrams illustrating operations of various elements of a system for secure package delivery according to some embodiments.

FIG. 6 is a block diagram illustrating various elements of a system for secure package delivery according to further embodiments.

FIGS. 7 and 8 are flow diagrams illustrating operations of various elements of a system for secure package delivery according to some embodiments.

FIG. 9 is a flowchart illustrating operations of a mobile computing device associated with verification of package delivery and payment for package delivery according to some embodiments.

FIG. 10 is a flowchart illustrating operations of a transaction server associated with verification of package delivery and payment for package delivery according to some embodiments.

### DETAILED DESCRIPTION OF EMBODIMENTS

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

As noted above, COD remains a popular method of payment in many countries, since it allows a purchaser to verify that the delivery has been successfully made before issuing payment to the vendor. However, a problem arises as payment for COD deliveries is increasingly made using credit cards, debit cards or electronic payment methods. Namely, when the purchaser receives the delivery, they may be required to present a credit card or debit card to the delivery person for payment. The delivery person typically reads, or “swipes,” the card using a handheld credit card reader, which processes the transaction. If the transaction is successful, the credit card reader prints a receipt for the purchaser.

This process creates a risk by exposing the credit or debit card information to the delivery person. An unscrupulous delivery person may gain knowledge of the credit/debit card number while conducting the transaction by, for example, scanning the card using an unauthorized “skimming” device or simply by making a note of the credit card number, expiration date, card security code (CSC) and the name of the cardholder. Moreover, the delivery person may have knowledge of the address of the cardholder, since the cardholder address likely corresponds to the delivery address. With this information, an unscrupulous delivery person may be able to engage in fraudulent transactions using the acquired card information, to the detriment of the delivery recipient/purchaser, the card issuer and even to the vendor due to loss of confidence by the purchaser.

Another concern is that a delivery person may intentionally or unintentionally deliver the wrong package to the recipient, which the recipient may not find out until the package is opened.

Some embodiments of the inventive concepts described herein provide systems, methods, computing devices and computer program products that enable a recipient/purchaser to make payment for goods delivered to the recipient/purchaser without having to share payment information, such as credit card information, debit card information, gift card information, electronic payment account information or other sensitive financial information with the delivery person.

In particular, some embodiments provide mobile computing systems/methods that securely conduct a COD transaction. The mobile computing system electronically reads a package shipment code on a package that has been tendered for delivery by a courier. The package shipment code is transmitted to a transaction server which processes the transaction code and sends a confirmation message to the mobile computing system. The confirmation message indicates that the correct package has been delivered and may provide a validated payment amount. The mobile computing system displays the confirmation message to a user and receives payment authorization from the user for the validated payment amount. In response to receiving payment authorization, the mobile computing system sends payment information to a payment processing server, which processes the payment on behalf of the package vendor. Once payment has been verified, the vendor can instruct the delivery person via electronic message to release the package. Thus, the user may not need to provide any payment information to the courier in order to conduct the COD transaction.

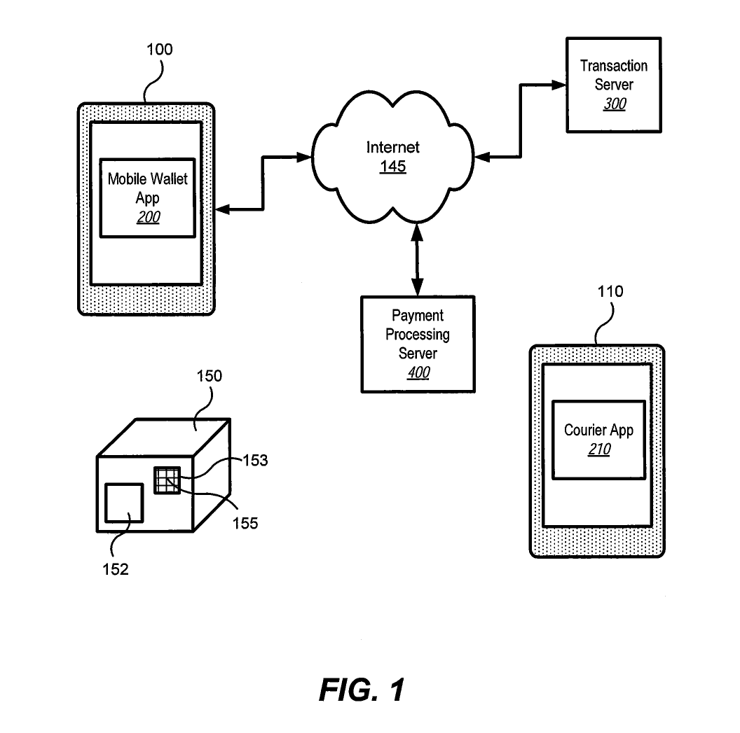

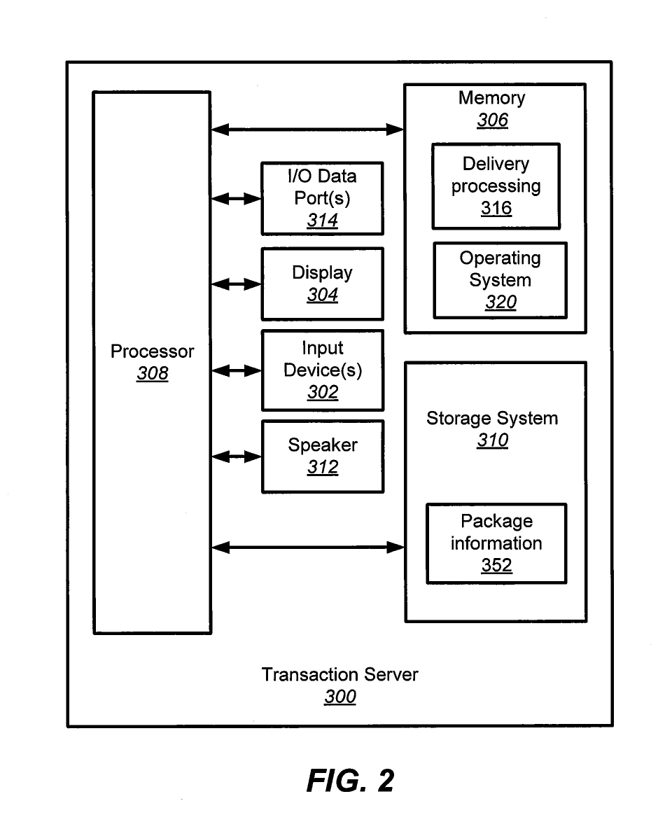

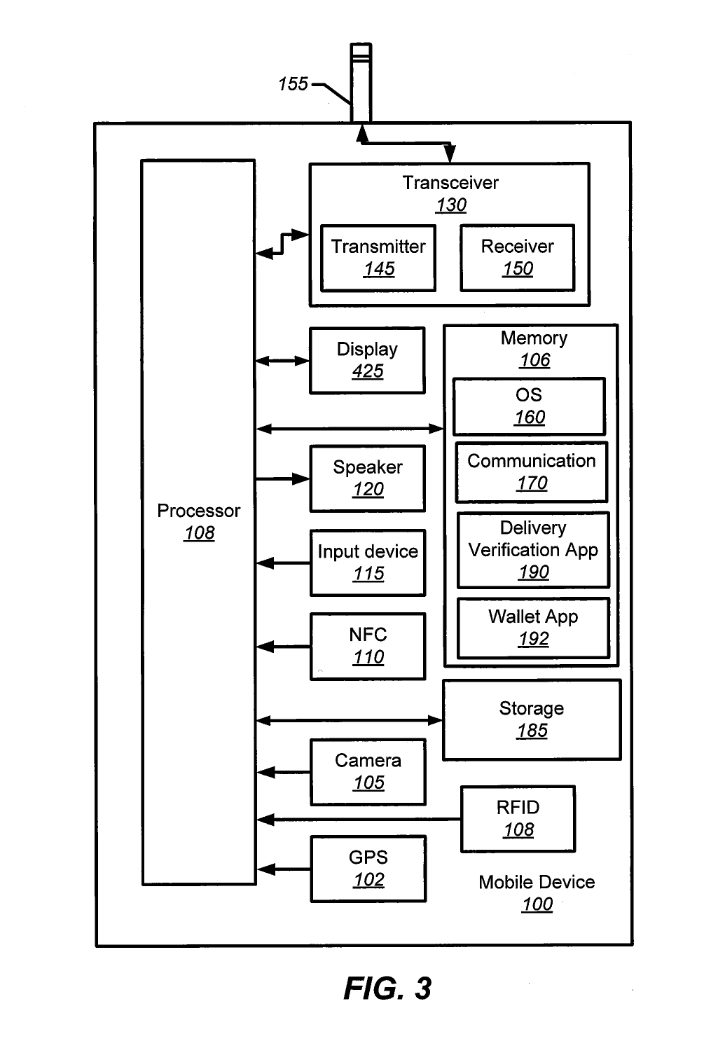

FIG. 1 is a block diagram illustrating various elements of a system for secure package delivery according to some embodiments, and FIGS. 2 and 3 are flow diagrams illustrating operations of various elements of a system for secure package delivery according to some embodiments.

Referring to FIG. 1, a system for secure package delivery includes a mobile computing device 100 on which a delivery verification application (or “delivery verification app,” or simply “delivery app”) 200 is installed an operating. The system further includes a transaction server 300 and a payment processing server 400. The mobile computing device 100, the transaction server 300 and the payment processing server 400 may each be configured to communicate over a public data communications network 145, such as the Internet. Alternatively or additionally, these devices may be configured to communicate over one or more private data communications networks, such as Intranets, virtual private networks, mobile communications networks, or other communications networks. A package delivery person who is employed by a courier company may also have a mobile computing device 110 on which a courier app 210 is installed and operating.

Although illustrated as separate entities, the transaction server 300 and the payment processing server 400 may be implemented as separate modules on the same computing device. The devices may be co-located and/or remotely located from one another. They may be operated by the same or different entities.

Operations described herein assume that a package is being delivered to a recipient, who is, or is associated with, a user of the mobile communications device 100. The user of the mobile communications device 100 may be referred to hereinafter simply as the “recipient” or the “user.”

FIG. 1 also illustrates a package 150 that is to be delivered to the recipient. The package 150 includes an address label 152 and a code, token, feature or other device 153 that includes or encodes a package shipment code 155. Although illustrated as separate from the address label 152, the device 153 may be printed on or enclosed within or under the address label 152, or even within the package 150 itself. The device 153 may be arranged to prevent/obstruct removal or tampering of the feature before the package is opened.

The device 153 may include an optically readable code, such as a barcode, QR code, data glyph, or other one- or two-dimensional optical code. In some embodiments, the device 153 may include an RF-scannable device, such as an RFID tag.

The device 153 may encode the package shipment code 155. That is, the package shipment code 155 may be obtained from the device 153 using an appropriately configured scanner, such as a barcode scanner. In particular embodiments, the package shipment code 155 may be obtained from the device 153 using a digital camera or an RFID scanner.

The package shipment code that is read from the device 153 may include a secure encrypted code along with a checksum or cyclic redundancy code (CRC) to ensure integrity of the package shipment code. When the encrypted package shipment code including CRC bits is decrypted, the CRC may be recalculated and compared against the recovered CRC to verify that the package shipment code is genuine. Data encryption and CRC generation are well known in the art.

In some embodiments, the package shipment code may simply comprise a number that can be referenced to obtain information about the package to which it is affixed. In other embodiments, the package shipment code may include information about the package, including package contents, delivery address, recipient name, vendor name, courier name, COD payment amount, etc. Some two-dimensional barcodes can encode a large number of characters. For example, a High Capacity Color Barcode (HCCB) can encode up to 3500 characters per square inch, while a QR code may encode over 4000 alphanumeric characters. RFID, which typically encode a limited number of characters, may be suitable for encoding a numeric package shipment code.

FIG. 2 illustrates aspects of a transaction server 300 according to some embodiments. The transaction server 300 includes a processor 308 that communicates with a memory 306, a storage system 310, and one or more I/O data ports 314. The transaction server 300 may also include a display 304, an input device 302 and a speaker 312. The memory 306 stores program instructions and/or data that configure the transaction server 300 for operation. In particular, the memory 306 may store a delivery processing module 316 and an operating system 320. The delivery processing module 316, among other tasks, performs the operations of receiving and verifying shipment codes, sending and receiving payment information, and sending and receiving payment verification as described herein.

The storage system 310 may include, for example, a hard disk drive or a solid state drive, and may include a package information storage 352 that stores information regarding packages for which a shipment code is received. For example, the package information storage 352 may be implemented as a database that contains records corresponding to package shipment codes. The records may include information about the shipments, including, for example, package contents, delivery address, recipient name, vendor name, courier name, COD payment amount, etc.

A mobile computing device 100 according to some embodiments is illustrated in FIG. 3. The mobile computing device 100 includes a processor 108 that communicates with a memory 106, a storage 185, and a transceiver 130. The transceiver 130 is coupled to an antenna 155 and includes a transmitter 145 and a receiver 150 that enable the mobile computing device 100 to communicate over one or more wireless data networks, such as WCDMA, 3G LTE, Wifi, and the like. It will be appreciated that a separate wifi transceiver, Bluetooth transceiver, or other transceiver may also be included in the mobile computing device 100. The mobile computing device 100 may also include a display 125, one or more input devices 115, such as a keypad, touchscreen and/or microphone, a speaker 120, a near field communications (NFC) module 110, an RFID scanner 108, a camera 105 and a GPS receiver 102. The memory 106 stores program instructions and/or data that configure the mobile computing device 100 for operation. In particular, the memory 106 may store an operating system 160, a communication module 170, and a package delivery application (app) 190 that enables the mobile computing device 100 to perform operations described herein. The memory 106 may also store a wallet app 192 that contains payment card information, such as credit card and/or debit card information, and/or electronic payment account credentials (e.g. PayPal credentials).

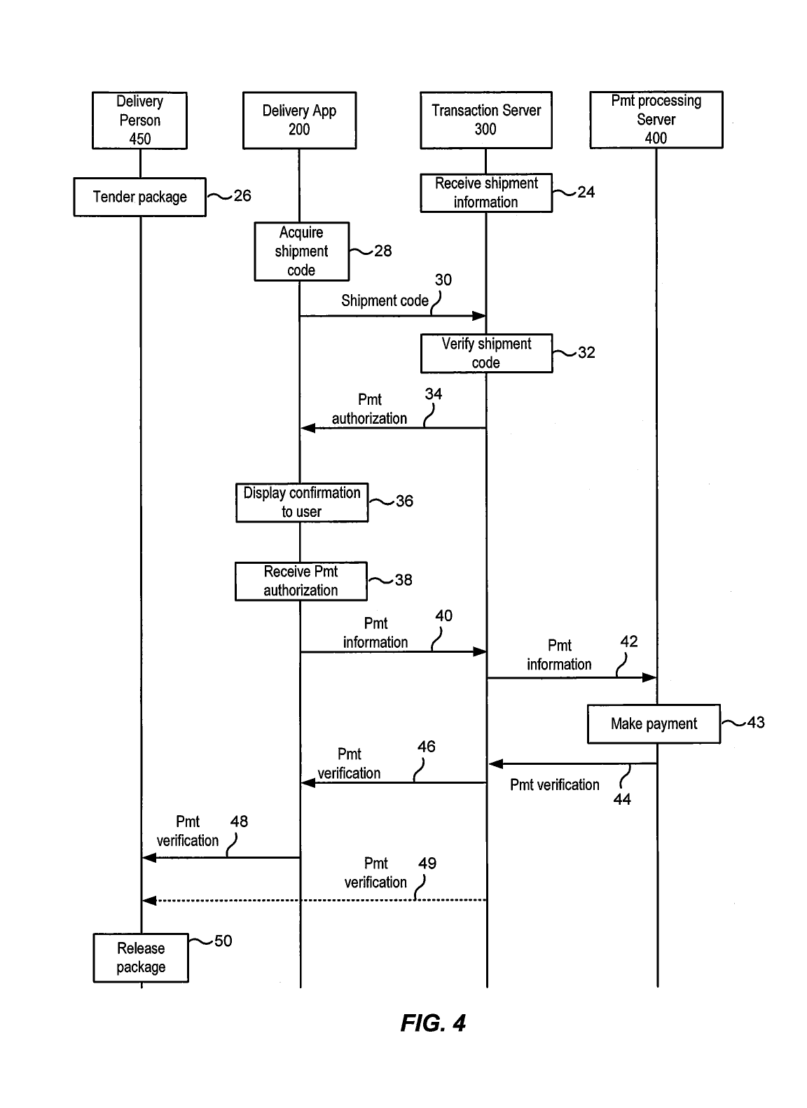

FIG. 4 illustrates various actions by a courier 600, a delivery verification app 200 on a mobile computing device operated by a package recipient, a transaction server 300 and a payment processing server 400. In some embodiments, when a package is sent for delivery to a recipient by a vendor, the vendor may supply the transaction server 300 with shipment information that describes the shipment (block 24). The shipment information may include the package shipment code along with information about the package, including package contents, delivery address, recipient name, vendor name, courier name, COD payment amount, etc. Thus, the transaction server 300 may be aware of the shipment before delivery is made to the recipient. However, in some embodiments, the transaction server may not receive shipment information before the package is delivered, as will be described in more detail below.

Still referring to FIG. 4, operations of the delivery verification app 200 begin when a courier 450 tenders a package 150 for delivery to a recipient (block 26). The recipient may activate the delivery verification app 200 that is installed on a mobile computing device 100. The delivery verification app 200 may use the mobile computing device 100 to acquire the package shipment code 155 from the package 150 (block 28). For example, as described above, the delivery verification app 200 may use a digital camera included within the mobile computing device 100 to scan an optical code, such as a one- or two-dimensional barcode, or the delivery verification app 200 may use an RFID reader within the mobile computing device 100 to scan an RFID tag included on or within the package 150. Any suitable method for acquiring the package shipment code may be used, including near field communications (NFC), optical character recognition, etc.

The delivery verification app 200 then transmits the package shipment code to the transaction server 300, for example, over a public or private wireless communication network (e.g., wifi, 3G LTE, etc.) that provides a gateway to the Internet (arrow 30). The transaction server 300 verifies the package shipment code (block 32). If the package shipping code is encrypted, the transaction server 300 may first decrypt the package shipment code and verify the integrity of the code by checking the CRC bits.

If the transaction server 300 has already received the package shipment code from the vendor along with the shipping information (block 24), the transaction server 300 may retrieve the record associated with the package shipment code from the package information database 352. Otherwise, the transaction server 300 may query the vendor for the shipping information by sending the package shipment code to the vendor, and the vendor may provide the shipping information in response to the query.

In some embodiments, the delivery verification app 200 may also transmit a geographic location and/or an address at which the mobile computing device 100 is physically located. The geographic location of the mobile computing device 100 may be obtained, for example, from a GPS module in the mobile computing device 100.

The transaction server may check the address of the mobile computing device 100 against the delivery address contained in the shipping information associated with the package shipment code to verify that the delivery is being made to the correct location.

If the package shipment code is invalid, or if the package shipment code does not match a package shipment code in the package information database 352, or if the vendor response indicates that the package shipment code is unknown, the transaction server 300 may send a negative response to the delivery verification app 200 indicating that the package shipment code is invalid, and the recipient may decline to accept the package.

Once the package shipment code has been verified by the transaction server 300, the transaction server 300 may send a payment authorization 34 to the delivery verification app 200. The payment authorization may include a payment amount for the package that the recipient is asked to verify and approve. The delivery verification app 200 displays a confirmation message to the recipient (block 36) and prompts the recipient for authorization to release payment for the package (block 38). If the recipient grants authorization (for example, by selecting a designated button or icon on the screen of the mobile computing device 100), the delivery verification app 200 transmits payment information to the transaction server (arrow 40). The payment information may be obtained, for example, from the wallet app 192, which stores credit card and/or debit card information, and/or electronic payment account credentials (e.g. PayPal credentials). In the case of credit/debit card information, the payment information may be in the form of a payment token or cryptogram that is generated by the wallet app 192. In the case of electronic payment account information, the information may be encrypted and transmitted over a secure connection between the delivery verification app 200 and the transaction server 300.

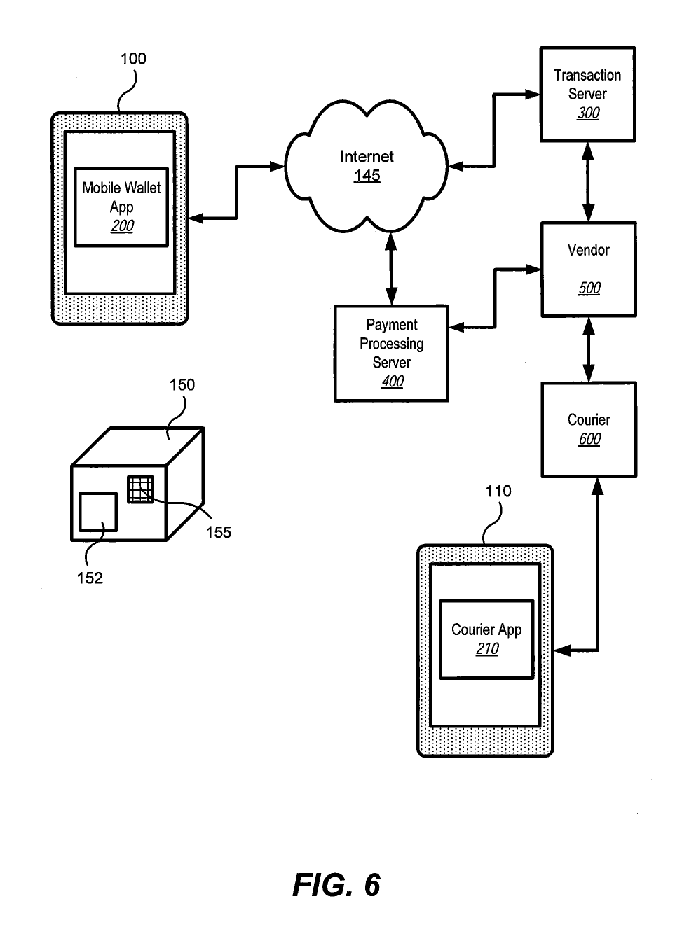

The transaction server 300 receives the payment information and forwards the payment information to a payment processing server 400 (arrow 42). The payment processing server 400 may be designated by the vendor. If the payment credentials are valid, the payment processing server 400 makes the payment (block 43) and returns a payment verification (arrow 44), and in response, the transaction server 300 sends a payment verification to the delivery verification app 200 (arrow 46). The payment verification may then be provided to the courier 450 (arrow 48), who releases the package to the recipient in response to the payment verification (block 50). In some embodiments, the package information may include an address of a courier computing system 600 (FIG. 6) operated by the courier, and the transaction server 300 may send the payment verification (arrow 49) to the courier 450 via the courier computing system 600.

Payment verification may be provided in the form of a QR code that can be scanned by the courier app 210 or an NFC communication that can be received by the mobile computing device 110 that belongs to the courier.

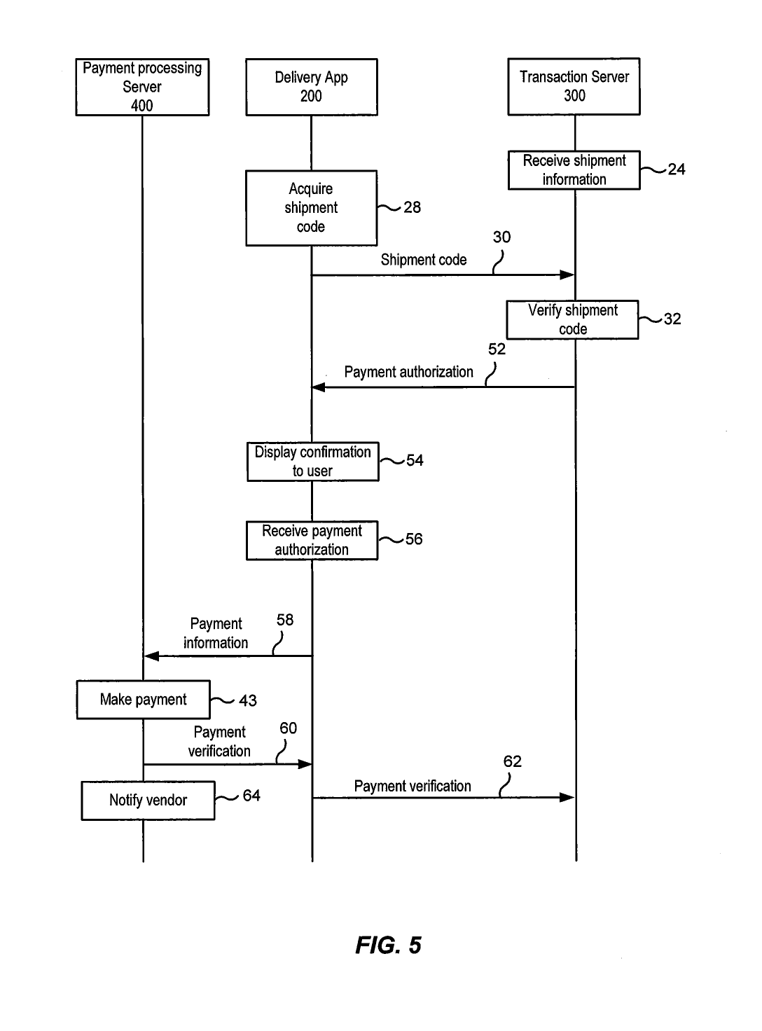

FIG. 5 is a flow diagram that illustrates operations according to further embodiments. In FIG. 5, like numbers refer to like operations shown in FIG. 4. In the embodiments of FIG. 5, the delivery confirmation app communicates directly with the payment processing server.

Referring to FIG. 5, the payment authorization received at the delivery confirmation app 200 from the transaction server 300 (arrow 52) may include payment instructions that indicate where the delivery verification app 200 should transmit payment information. The payment instructions may, for example, include a uniform resource identifier (URI) that allows the delivery verification app 200 to locate the payment processing server 400 on the Internet.

In response, the delivery verification app 200 displays a confirmation message 54 to the recipient and obtains authorization from the recipient to make the payment (block 56).

Upon receipt of authorization from the recipient, the delivery verification app 200 transmits the payment information (e.g. a payment token/cryptogram or encrypted account credentials) to the payment processing server 400 (arrow 58) and, if the payment information is verified, receives payment verification from the payment processing server 400 (arrow 60). The delivery confirmation app 200 may then inform the transaction server 300 that the transaction has been successfully concluded (arrow 62). The payment processing server may notify the vendor of the successful payment (block 64), and the vendor can notify the courier to release the package to the recipient.

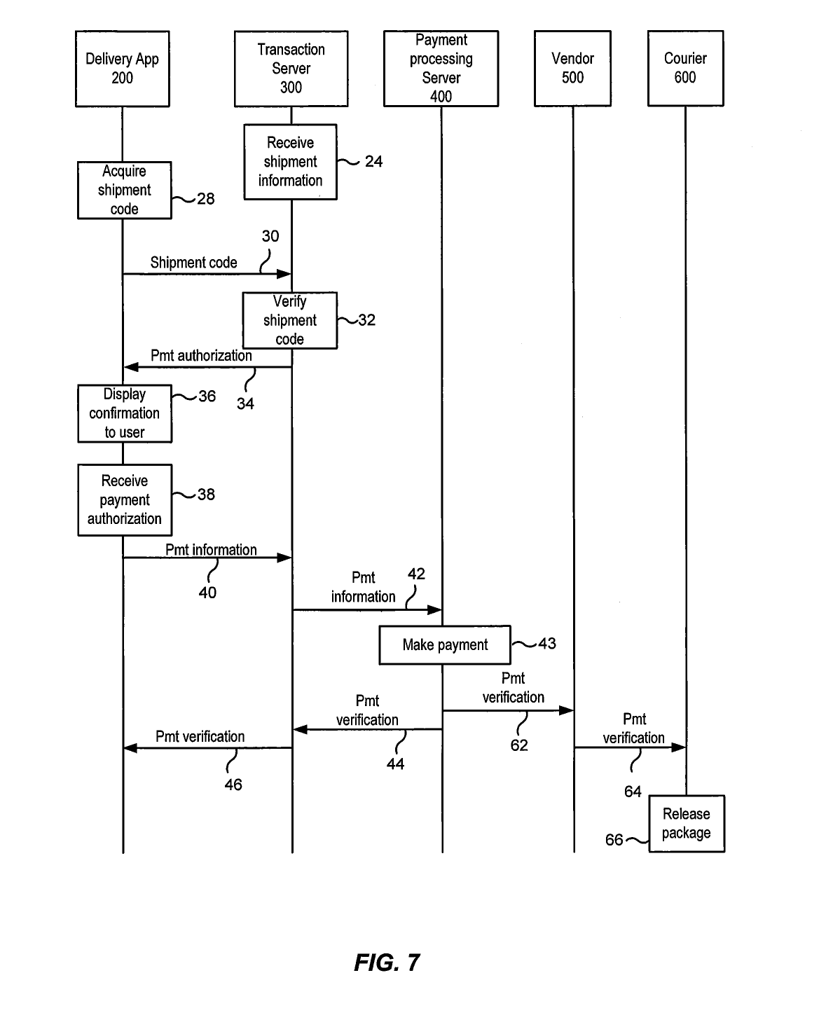

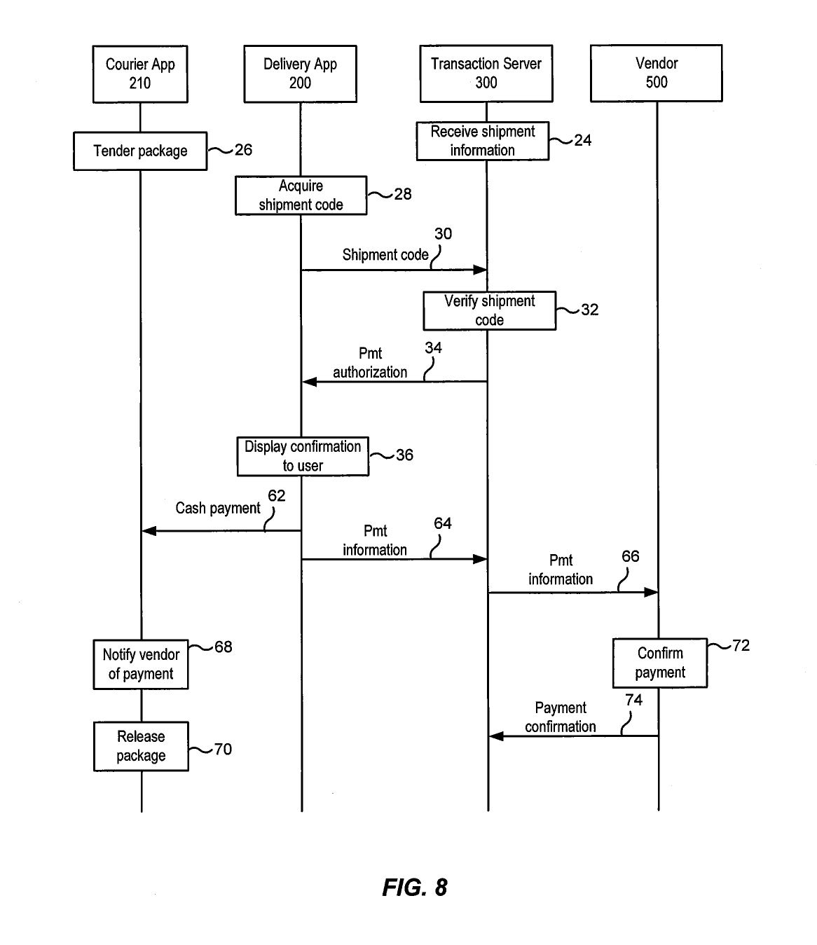

FIG. 6 illustrates some additional elements of a system for secure package delivery according to some embodiments, and FIGS. 7 and 8 are flow diagrams illustrating operations of various elements of a system for secure package delivery according to further embodiments.

Referring to FIG. 6, in addition to a mobile computing device 100 on which a delivery verification app 200 is installed, a transaction server 300 and a payment processing server 400, the system includes a vendor computing system 500 and a courier computing system 600. The vendor computing system 500 may include one or more servers operated by the vendor from which the package was sent, while the courier computing system 600 may include one or more servers operated by the courier that is responsible for delivering the package.

The vendor computing system 500 and the courier computing system 600 may be configured to communicate with one another over one or more public or private communication links, including the Internet 145. In addition, the courier computing system 600 is configured to communicate with the mobile computing device 110 carried by the delivery person. The vendor computing system 500 is also configured to communicate with the transaction server 300 and the payment processing server 400 over one or more public or private communication links, including the Internet 145.

Although the vendor computing system 500 and the transaction server 300 are illustrated as separate items, it will be appreciated that the transaction server 300 could be implemented within the vendor computing system 500.

FIG. 7 is a flow diagram that illustrates operations according to further embodiments. In FIG. 7, like numbers refer to like operations shown in FIG. 3. In the embodiments of FIG. 7, the payment processing server communicates with the vendor computing system 500, while the vendor computing system 500 communicates with the courier computing system 600.

Referring to FIG. 7, after payment information is provided to the payment processing server 400 (arrow 42) and the payment processing server 400 makes the payment in block 43, the payment processing server 400 sends a payment verification to the vendor computing system 500 (arrow 62) indicating that the recipient has successfully paid for the package. The vendor computing system 500 then notifies the courier computing system 600 of the completed payment by sending a payment verification (arrow 64) to the courier computing system 600, which notifies its delivery person to release the package to the recipient (block 66).

Some embodiments of the inventive concepts can facilitate secure payment by the recipient using cash. For example, FIG. 8 is a flow diagram that illustrates operations according to embodiments in which cash is used to pay for a package delivery. In FIG. 8, like numbers refer to like operations shown in FIG. 3.

Referring to FIG. 8, after the shipment code verification is displayed to the recipient at block 36, the recipient may select “cash payment” as an option on the delivery verification app 200. The delivery verification app 200 then sends payment information (arrow 64) to the transaction server 300 indicating that cash is being used to pay for the delivery. The payment information is forwarded to the vendor computing system 500.

Meanwhile, the recipient gives the cash payment to the delivery person (arrow 62), who uses the courier app 210 to notify the vendor that a cash payment has been received in the requested amount (block 68), and the courier app 210 indicates that the delivery person can release the package to the recipient (block 70).

Upon notification by the courier app 210 that the cash payment has been received, the vendor computing system 500 confirms the payment by comparing the payment notification received from the courier app 210 with the payment information provided by the transaction server 300 (block 72), and in response sends the transaction server 300 a payment confirmation (arrow 74).

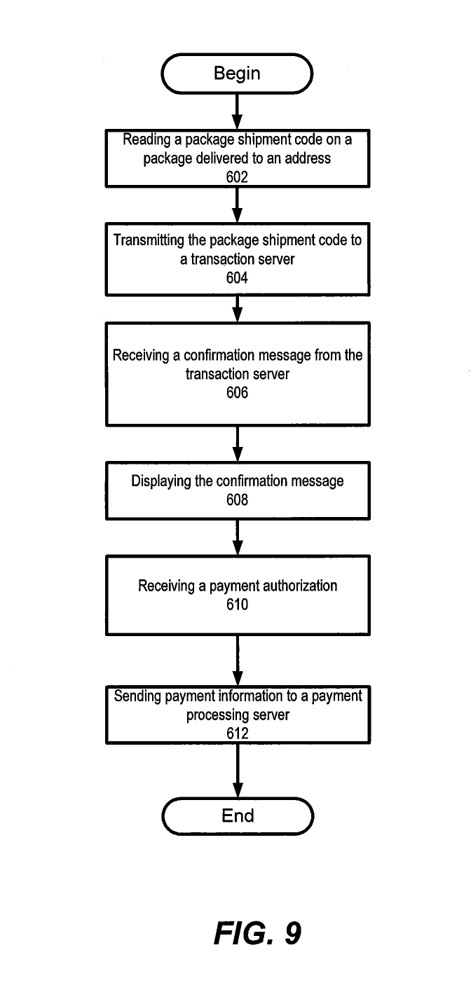

Operations of mobile computing device 100 according to some embodiments are illustrated in FIG. 9. As shown therein, the operations begin when a delivery app 200 on the mobile computing device 100 reads or scans a package shipment code on a package that is to be delivered to an address (block 602). The operations then include transmitting the package shipment code to a transaction server (block 604), and receiving a confirmation message from the transaction server confirming that the package shipment code is verified (block 606). The confirmation message may include a transaction amount to be authorized by the recipient.

The operations further include displaying the confirmation message (block 608), for example, on a display screen of the mobile computing device 100, and receiving a payment authorization in response to the confirmation message (block 610). In response to receiving the payment authorization from the user, the delivery verification app 200 sends payment information to a payment processing server 300 (block 612).

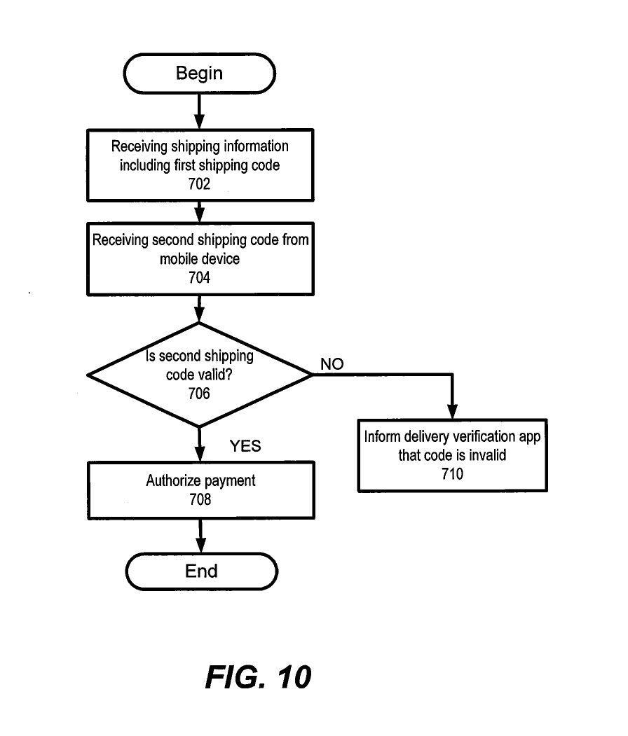

FIG. 10 is a flowchart illustrating operations of a transaction server associated with verification of package delivery and payment for package delivery according to some embodiments. Referring to FIG. 10, a transaction server 300 receives shipping information including a first shipping code (block 702). The shipping information may be received, for example, from a vendor computing system 500 (FIG. 6).

The transaction server 300 also receives a second shipping code from a mobile computing device on which a delivery verification app 200 is running (block 704). The transaction server 300 determines if the second shipping code is valid (block 706), for example, by comparing the second shipping code to the first shipping code. In some embodiments, the transaction server 300 may determine if the second shipping code is valid by sending the second shipping code to the vendor computing system 500 and asking the vendor computing system to verify the second shipping code.

If the second shipping code is valid, the transaction server 300 sends a message to the delivery verification app 200 authorizing the user to accept shipment and pay for the shipment (block 708). Along with the message, the transaction server 300 may send the delivery verification app 200 an amount that is authorized for payment. The message may also include a description of the goods being delivered to allow the user to confirm that the package contains the correct contents.

Otherwise, if the second shipping code is invalid, the transaction server may inform the delivery verification app 200 that the second shipping code is invalid (block 710).

In the above-description of various embodiments of the present disclosure, aspects of the present disclosure may be illustrated and described herein in any of a number of patent-eligible classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method comprising:
performing operations as follows on a processor of a mobile computing device:
electronically reading a package shipment code on a package delivered to an address;
transmitting the package shipment code to a transaction server;
receiving a confirmation message from the transaction server, the confirmation message comprising a transaction amount;
displaying the confirmation message to a user;
receiving a payment authorization from the user in response to the confirmation message; and
sending payment information to a payment processing server in response to receiving the payment authorization from the user.

2. The method of claim 1, further comprising:
receiving a payment token;
wherein sending the payment information to the transaction server comprises sending the payment token to the transaction server

3. The method of claim 1, wherein reading the package shipment code on the package comprises scanning a visible symbol printed on the package.

4. The method of claim 3, wherein the visible symbol comprises a bar code and/or a QR code.

5. The method of claim 3, wherein reading the package shipment code further comprises reading package information about the package from the visible symbol.

6. The method of claim 5, further comprising transmitting the package information to the transaction server along with the package shipment code.

7. The method of claim 5, wherein the package information comprises a shipping address, the method further comprising transmitting the package information including the shipping address to the transaction server along with the package shipment code.

8. The method of claim 1, further comprising receiving a payment confirmation from the payment processing server.

9. The method of claim 1, further comprising generating a cryptogram that includes an encoded payment key in response to receiving the payment authorization, wherein the payment information includes the cryptogram.

10. A method comprising:
electronically reading a package shipment code on a package delivered to an address;
transmitting the package shipment code to a transaction server;
receiving a confirmation message from the transaction server, the confirmation message comprising a transaction amount;
displaying the confirmation message to a user;
receiving a payment authorization from the user in response to the confirmation message;
transmitting a payment verification to the transaction server in response to the payment authorization; and
receiving a payment confirmation from the transaction server in response to the payment verification.

11. A method comprising:
performing operations as follows on a processor of a computing device:
receiving shipment information from a vendor, the shipment information describing a shipment of a package to a recipient and comprising a first package shipment code;
receiving a second package shipment code from a mobile computing device associated with the recipient;
comparing the first package shipment code and the second package shipment code;
if the first and second package shipment codes match, sending a payment authorization to the mobile computing device authorizing the recipient to accept the package and pay for delivery of the package.

12. The method of claim 11, further comprising:
receiving payment information from the mobile computing device; and
forwarding the payment information to a payment processor that processes payments on behalf of the vendor.

13. The method of claim 12, wherein the payment information comprises a cryptogram including payment card information.

14. The method of claim 12, wherein the payment information comprises electronic payment account credentials.

15. The method of claim 12, further comprising:
receiving a payment verification from the payment processor, the payment verification verifying that the payment information was successfully processed; and
transmitting the payment verification to the mobile computing device.

16. The method of claim 15, wherein the shipment information identifies a courier server operated by a courier service that delivers the package to the recipient, the method further comprising:
transmitting a message to the courier server authorizing the courier service to release the package to the recipient.

17. The method of claim 11, further comprising:
receiving payment information from the mobile computing device; and
forwarding the payment information to a vendor server operated by the vendor.

18. The method of claim 11, wherein the payment authorization comprises a payment amount.

19. The method of claim 11, further comprising sending a message to the vendor requesting the shipping information after receiving the second shipment code from the mobile computing device.

20. The method of claim 11, wherein the shipping information comprises a decryption key, the method further comprising decrypting the first package shipping code using the decryption key.
